(19) United States
(12) Patent Application Publication
(10) Pub. No.: US 2026/0023650 A1
(43) Pub. Date: Jan. 22, 2026

(54) APPARATUS FOR MANAGING VERIFICATION PROCESS IN STORAGE SYSTEM

(71) Applicant: Hitachi Vantara, Ltd., Yokohama-shi (JP)

(72) Inventor: Ryo NISHIKATA, Yokohama-shi (JP)

(21) Appl. No.: 19/073,289

(22) Filed: Mar. 7, 2025

(30) Foreign Application Priority Data
Jul. 19, 2024 (JP) 2024-115677

(51) Int. Cl. G06F 11/10; G06F 11/273; G06F 11/277

(52) U.S. Cl. CPC G06F 11/1076; G06F 11/2733; G06F 11/277

(57) ABSTRACT

An apparatus for managing a verification process in a storage system includes a processor and a storage device. The processor determines an amount of data stored in a target logical device of a verification process, determines a timeout period of the target logical device based on the amount of data, and controls the verification process of the target logical device based on the determined timeout period.

### CLAIM OF PRIORITY

The present application claims priority from Japanese patent application JP 2024-115677 filed on Jul. 19, 2024, the content of which is hereby incorporated by reference into this application.

### BACKGROUND OF THE INVENTION

### 1. Field of the Invention

The present invention relates to management of a verification process in a storage system.

### 2. Description of Related Art

As a background art of the present disclosure, there is JP2000-293318A. JP2000-293318A discloses a disk array device that reduces detection of a media error, which can be remedied by a retry process, as a timeout error by increasing a setting value of time monitoring of a hard disk device in a stepwise manner (see, for example, Abstract).

As one of tests of a storage system, verification is known. The verification checks consistency of data distributed in a parity group (also referred to as a redundant array of independent disks (RAID) group) in order to mainly check an occurrence of write omission.

A test apparatus designates an LDEV (logical device or volume) symmetrical to a storage system and instructs the execution of the verification. The storage system checks consistency of data of the designated LDEV. For example, in the data consistency check, pieces of user data of two LDEVs are compared in RAID1, or one or two parities generated from the pieces of user data in RAID5 or RAID6 are compared with parities stored in a drive.

### CITATION LIST

### Patent Literature

PTL 1: JP2000-293318A

### SUMMARY OF THE INVENTION

For example, in the test of the storage system, the test apparatus receives a verification result from the storage system. However, the verification may not progress and the progress of the test may stop.

According to an aspect of the invention, there is provided an apparatus for managing a verification process in a storage system, and the apparatus includes a processor and a storage device. The processor determines an amount of data stored in a target logical device of a verification process, determines a timeout period of the target logical device based on the amount of data, and controls the verification process of the target logical device based on the determined timeout period.

According to a typical embodiment of the invention, the verification process of the storage system can be more appropriately controlled. Problems, configurations, and effects other than those described above will become apparent in the following description of embodiments.

### BRIEF DESCRIPTION OF THE DRAWINGS

FIG. 1 schematically shows a test environment of a storage system according to an embodiment of the present specification;

FIG. 2 shows a configuration example of the storage system;

FIG. 3 is a diagram showing a hardware configuration example of a test execution client according to the embodiment of the present specification;

FIG. 4 shows a configuration example of a timeout period derivation table;

FIG. 5 shows a configuration example of the timeout period derivation table; and

FIG. 6 shows a flowchart of a processing example of verification management and control by a maintenance failure tool.

### DESCRIPTION OF EMBODIMENTS

An embodiment will be described with reference to the drawings. First, prerequisites in the following description will be described.

First, the embodiment described below does not limit the invention according to the range of claims, and it is not necessary that all of the elements and combinations described in the embodiment are essential to the solution of the invention.

Second, in the following description, a method of storing data or control information may be described using a data structure such as a “table” or a “list”, but different data structures that provide an equivalent representation may be used. In the following description, in order to distinguish items stored in a table, a list, or the like, an integer ID may be assigned to each item, but these IDs may be expressed in another ID format having uniqueness. Examples of another ID format include a Globally Unique ID (GUID) and a character string.

Third, in the following description, a process may be described using a “program” as a subject, but the program is interpreted and executed by a central processing unit (CPU), and the CPU controls components such as a memory and a port as necessary in order to execute the process described in the program. The CPU may execute the process described in the program by using an appropriate hardware accelerator according to a content of the process instead of executing the process by itself. Examples of the hardware accelerator include a compression accelerator that executes compression and decompression of data instead of the CPU, and a DMA engine that executes data communication instead of the CPU.

Fourth, in the following description, an operation of a physical component and an operation of a logical data structure may be described without distinction, but it is assumed that the operation for the logical data structure is executed by the operation of the physical component abstracted by the data structure, and on the other hand, the operation of the physical component also involves an appropriate operation for the logical data structure that abstracts the component. For example, when a storage controller inputs and outputs data to and from a drive, the storage controller not only transmits and receives data to and from the drive, but also updates metadata existing in a control information area on a memory or a non-volatile memory, so that a state change associated with data input and output is appropriately reflected in a logical data structure such as a thin provisioning pool that abstracts the drive or a parity group to which the drive belongs.

The embodiment of the present specification manages a verification process of a logical device in a storage system. The verification process management sets a timeout period, and when an elapsed time from a start of the verification process reaches the timeout period, retry of the verification process is executed or the verification process is aborted. Accordingly, it is possible to reduce an unnecessary loss time when the verification process cannot be ended due to some failures. In addition, by repeating the retry, a frequency of failures of the verification process can be reduced.

In the embodiment of the present specification, the timeout period is set for a plurality of drives constituting a redundant array of independent disks (RAID) group (parity group) based on a RAID level. In the embodiment of the present specification, the timeout period is further set based on a type of the drives constituting the RAID group. In this manner, a more appropriate timeout period can be set by considering these items. Both the RAID level and the type of the drives are drive attributes.

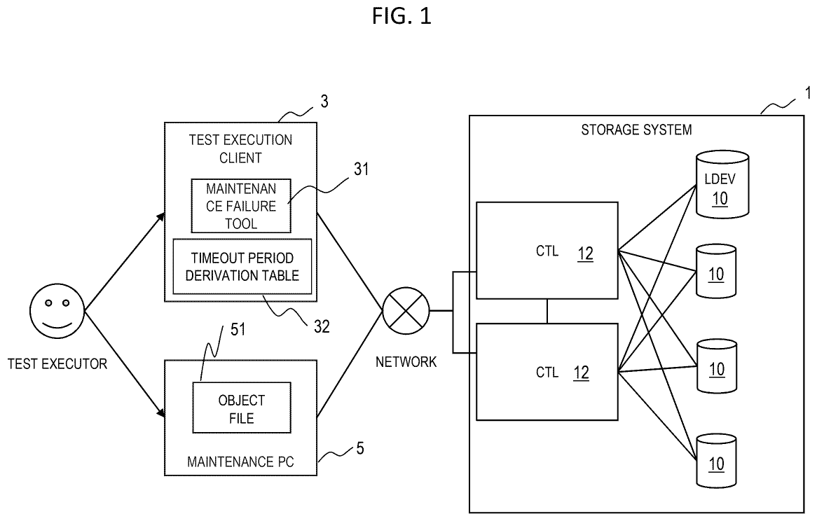

FIG. 1 schematically shows a test environment of a storage system according to the embodiment of the present specification. A test executor executes a test case for verifying a function of a storage system 1, and checks that the storage system 1 operates as designed. A test execution client 3 executes the test case instructed by the test executor on the storage system 1, and verifies the operation of the storage system 1. A maintenance personal computer (PC) 5 executes state monitoring and maintenance of the storage system 1. The storage system 1, the test execution client 3, and the maintenance PC 5 can communicate with one another via a network.

The maintenance PC 5 stores an object file 51, and installs the object file 51 in the storage system 1 in accordance with an instruction from the test execution client 3. The object file 51 is a program to be executed by the storage system 1, and executes the verification process of data stored in the storage system 1. After a test of the storage system 1 is completed, the object file 51 may be deleted from the storage system 1.

A combination of the maintenance PC 5 and the storage system 1 is implemented in an execution environment. Although FIG. 1 shows a pair of the maintenance PC 5 and the storage system 1, the test execution client 3 can simultaneously execute tests of a plurality of combinations of the maintenance PC 5 and the storage system 1.

The test execution client 3 stores a maintenance failure tool 31 and a timeout period derivation table 32. The maintenance failure tool 31 is a program that includes a command related to the verification process and issues a maintenance operation command to the storage system 1. The maintenance failure tool 31 refers to the timeout period derivation table 32 to manage the execution of the verification process by the storage system 1. The timeout period derivation table 32 manages the timeout period of the verification process.

The storage system 1 includes one or more storage controllers (CTLs) 12 and one or more logical devices (LDEVs) 10. In the configuration example shown in FIG. 1, the storage system 1 includes two storage controllers 12 and a plurality of LDEVs 10.

The LDEV 10 is a logical storage area, and is also referred to as a volume. A storage area is allocated to the LDEV 10 from one or more of physical drives, and host data received from a host (not shown) is stored therein.

The storage controller 12 processes an IO request from the host (not shown). Specifically, in accordance with a write request, the storage controller 12 stores the host data received from the host at a designated address of the LDEV 10, reads the host data from the designated address of the LDEV, and transmits the host data to the host.

In the test of the storage system 1, the storage controller 12 executes the object file 51 installed and read from the maintenance PC 5. In the configuration example shown in FIG. 1, each storage controller 12 can access all the LDEVs 10. Further, normally, one of the storage controllers 12 processes the IO request and executes the object file 51, and when a failure occurs in the one storage controller 12, the other one of the storage controllers 12 executes the object file 51 on behalf of the one storage controller 12.

Each storage controller 12 further executes a process according to a command from the test execution client 3. In the embodiment of the present specification, each storage controller 12 executes the verification process of the designated LDEV in response to the command from the test execution client 3. The verification process is executed under management and control of the test execution client 3.

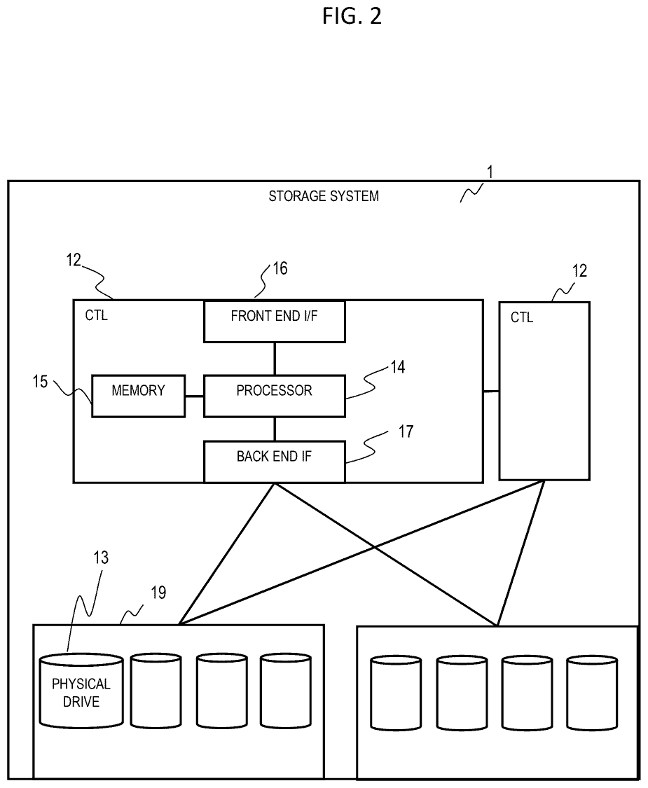

FIG. 2 shows a configuration example of the storage system 1. The storage system 1 includes one or more storage controllers 12 and one or more physical drives 13. In the configuration example of FIG. 2, two storage controllers 12 and a plurality of physical drives 13 are mounted.

The storage controller 12 is connected to other devices, for example, the host, the test execution client 3, and the maintenance PC 5 via a front end interface 16, receives various commands, and can transmit and receive data. A host interface connected to the host may be different from a management interface connected to the test execution client 3 or the maintenance PC 5, which is another management device. Examples of a connection form between the storage controller 12 and the host include an IP-storage area network (SAN). Examples of a connection form between the storage controller 12 and the test execution client 3 and a connection form between the storage controller 12 and the maintenance PC 5 include a LAN.

The storage controller 12 is connected to the physical drives 13 via one or more back end interfaces 17, issues various commands to the physical drives 13, and can transmit and receive data to and from the physical drives 13.

The physical drive 13 is also simply referred to as a drive, and is a non-volatile storage device. Examples of the drive 13 include a solid state drive (SSD) and a hard disk drive (HDD). The drive 13 may be stored in a drive box 19 independent of the storage controller 12 as shown in FIG. 2, or may be built in the storage controller 12. Examples of a connection form between the storage controller 12 and the drive 13 include a back end switch 100 capable of connecting a large number of NVMe drives to a single PCIe port.

The connections between the storage controllers 12 and the drives 13 do not require logical communication paths to be secured between all storage controllers 12 and all drives 13 as shown in FIG. 2, and each storage controller 12 may have logical communication paths secured only between the storage controller 12 and some of the drives 13.

The storage controllers 12 are connected by an inter-controller bus, and commands and data can be exchanged via the inter-controller bus. Each storage controller 12 exchanges commands and data with another storage controller 12 via the inter-controller bus with respect to the host or the drive 13 for which the logical communication path is not secured with the storage controller 12 itself, and thus can indirectly exchange commands and data with the host or the drive 13.

The storage controller 12 includes a processor 14 and a memory 15, and the processor 14 executes a control program on the memory 15. The processor 14 uses a cache area on the memory 15 as a temporary data storage area, and uses a partial area on the memory 15 as a control information storage area. The processor 14 exchanges data and commands between an external device and the drives 13 according to the description of the control program.

The control program, the control information, and the data in the cache area on the memory 15 are made non-volatile as necessary. A dedicated non-volatile memory may be mounted on the storage controller 12 in order to non-volatilize the control program, the control information, and the data in the cache area on the memory 15. Examples of the non-volatile memory include a solid state drive (SSD) and a storage class memory (SCM).

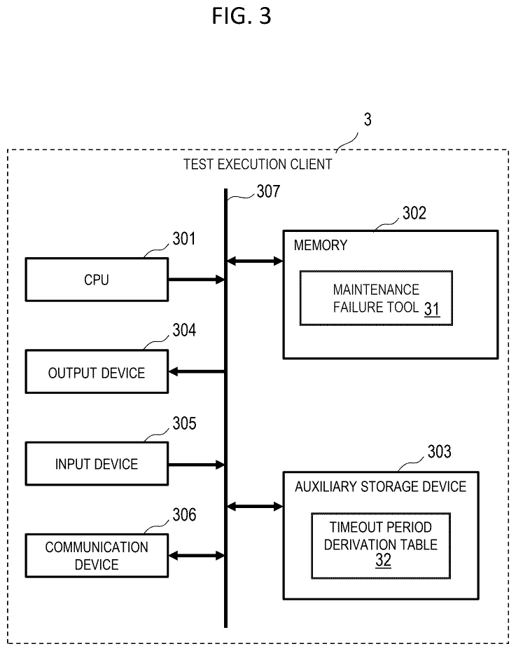

FIG. 3 is a diagram showing a hardware configuration example of the test execution client 3 according to the embodiment of the present specification. Hereinafter, a hardware configuration example of the test execution client 3 will be described, but the maintenance PC 53 may have the same configuration.

The test execution client 3 includes a CPU (processor) 301 that executes various programs, a memory (main storage device) 302 that stores various programs, and an auxiliary storage device 303 that stores various types of data. The CPU 301 can include one or more cores, and the memory 302 is, for example, a DRAM including a volatile storage area. The auxiliary storage device 303 is, for example, a hard disk drive (HDD) or a flash memory, and can provide a non-volatile storage area.

The test execution client 3 further includes an output device 304 for presenting information to a user of the device, an input device 305 for inputting instructions, images, and the like by the user, and a communication device 306 for communicating with other devices. These devices are connected to one another by a bus 307.

The CPU 301 reads and executes various programs from the memory 302 as necessary. The memory 302 can store the maintenance failure tool 31, an OS (not shown), and other application programs. For example, each program is loaded from the auxiliary storage device 303 to the memory 302, and is executed by the CPU 301. At least a part of functions of the test execution client 3 may be implemented by a logic circuit.

The auxiliary storage device 303 stores data referred to or managed by various programs. For example, the auxiliary storage device 303 stores the timeout period derivation table 32.

The output device 304 includes devices such as a display, a printer, and a speaker. The input device 305 includes devices such as a keyboard, a mouse, and a microphone. The output device 304 presents an input result from the user and a processing result obtained by the test execution client 3. An instruction from the user is input to the test execution client 3 by the input device 305.

The communication device 306 receives data transmitted from another device connected via a network including the storage system 1, and transmits the processing result obtained by the test execution client 3 to the another device. Note that some devices may be omitted. The description with reference to FIG. 3 can be applied to the hardware structure of the maintenance PC 5.

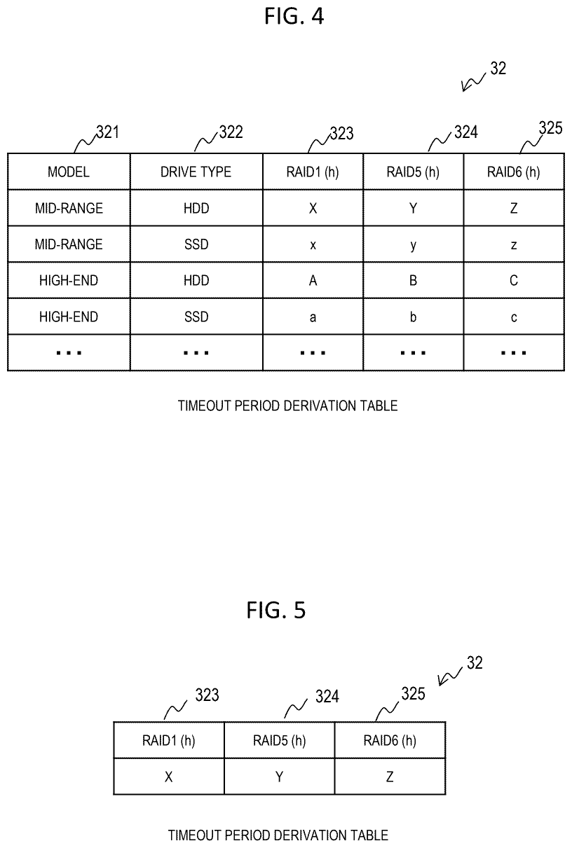

FIGS. 4 and 5 show a configuration example of the timeout period derivation table 32. The timeout period derivation table 32 defines a timeout period for each storage configuration (including a drive) that provides the LDEV. In the examples shown in FIGS. 4 and 5, the timeout period derivation table 32 indicates a timeout period (h) per 1 TB of data. The timeout period derivation table 32 indicates coefficients for calculating a prediction timeout period of an actual verification process for each LDEV.

In the configuration example shown in FIG. 4, the timeout period derivation table 32 includes a model field 321, a drive type field 322, a RAID1 (h) field 323, a RAID5 (h) field 324, and a RAID6 (h) field 325. Note that other RAID level information may be further included.

The model field 321 indicates a model of the storage system 1 (or the storage controller 12). Here, mid-range and high-end are shown as examples, but other levels may be included, and the model may be more specifically defined, such as by a model number. A difference in model indicates, for example, a difference in performance of the storage controller 12. The storage system 1 with higher performance can perform processing at a higher speed, and a time required for the verification process is shorter. According to this example, the timeout period suitable for the performance of the storage controller 12 can be defined.

The drive type field 322 indicates the type of the drive 13 that provides a storage area to the LDEV. Since the IO performance of the drives 13 of different types may be different, a timeout period suitable for each drive can be defined. For example, a time required for the verification process of data stored in the SSD is shorter than a time required for the verification process of data stored in the HDD.

The RAID1 (h) field 323, the RAID5 (h) field 324, and the RAID6 (h) field 325 indicate timeout periods (hour) of different RAID levels, respectively. A process for verifying data consistency differs depending on the RAID level. An appropriate timeout period can be defined according to the RAID level.

For example, data verification of the RAID1 compares actual data between mirrored drives. In data verification of RAID5, one parity created from the host data stored in a plurality of drives 13 is compared with one parity stored in another drive 13. In data verification of RAID6, two parities created from the host data stored in a plurality of drives 13 are compared with two parities stored in other drives 13. Therefore, the time required for the verification process under the same condition (the same model, the drive type, and the amount of data) is the shortest in the RAID5 and the longest in the RAID1.

FIG. 5 shows a simplified configuration example of the timeout period derivation table 32. The model field 321 and the drive type field 322 are omitted from the configuration example shown in FIG. 4. The RAID level has a greater influence on the time required for verification than the model and the drive type. Therefore, it is possible to efficiently perform appropriate verification process management and control. Note that only one of the model field 321 and the drive type field 322 may be omitted. Depending on the design, the RAID level fields 323 to 325 may be omitted, or the timeout period derivation table 32 may be omitted. The timeout period is determined according to the amount of data stored in the LDEV.

A process performed by the maintenance failure tool 31 will be described below. The maintenance failure tool 31 instructs the storage controller 12 in which the object file 51 is installed to perform the verification process of each LDEV, and manages and controls the process. The maintenance failure tool 31 determines the timeout period for each LDEV with reference to the timeout period derivation table 32. The timeout period is calculated according to the following equation.

$$Timeout period = coefficient of timeout period derivation table \times L D E V capacity \times L D E V usage rate [ \% ]$$

The coefficient acquired from the timeout period derivation table 32 is defined according to the model of the storage system 1, the drive type, and the RAID level in the configuration example of FIG. 4, and is defined according to the RAID level in the example of FIG. 5. Hereinafter, the timeout period derivation table 32 of the configuration example shown in FIG. 4 is assumed.

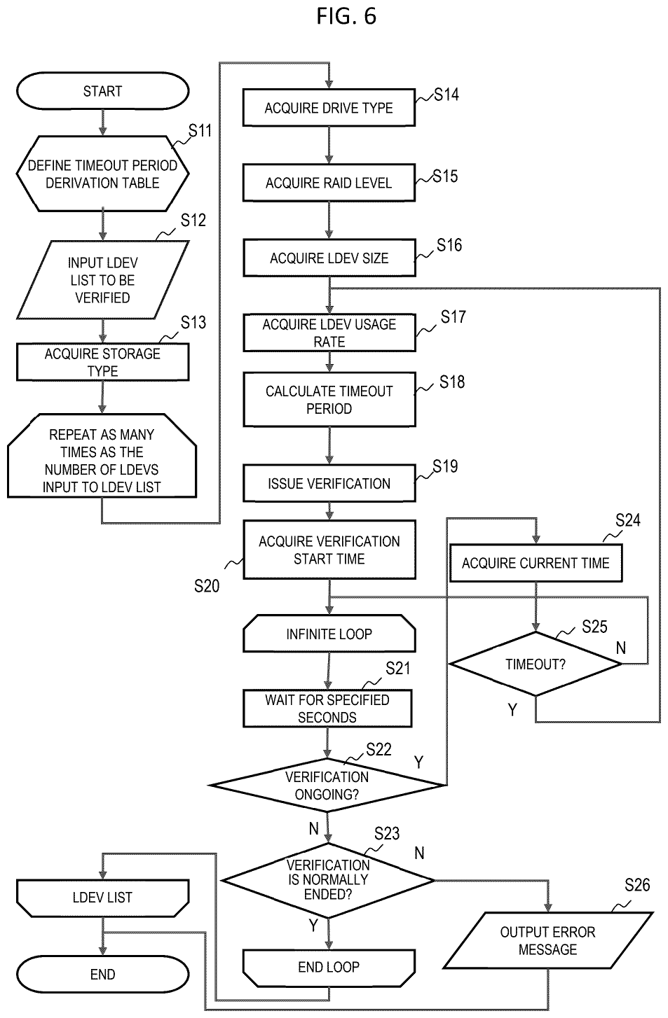

FIG. 6 shows a flowchart of a processing example of verification management and control by the maintenance failure tool 31.

The maintenance failure tool 31 defines the timeout period derivation table 32 in a pre-process (S11). Specifically, the maintenance failure tool 31 registers a maximum value (timeout period) of a processing time per TB in the timeout period derivation table 32 for each combination of the model, the drive type, and the RAID level according to an input from the user (the user who executes the test of the storage system 1).

The maintenance failure tool 31 then receives an LDEV list to execute the verification process (S12). For example, the user inputs identifiers of the plurality of LDEVs for which the verification process is to be executed by dividing the plurality of LDEVs by “,” (comma).

Next, the maintenance failure tool 31 acquires information on the model from the storage system 1 (S13). For example, the maintenance failure tool 31 logs in to the controller 12, and issues a command for acquiring model information. The maintenance failure tool 31 acquires the model information from the controller 12. For example, the model number is acquired from the storage system 1, and the maintenance failure tool 31 determines the model level of the timeout period derivation table 32 with reference to correspondence information between the model number and the model level (mid-range, high-end, or the like) held in advance.

The maintenance failure tool 31 executes the following steps for each LDEV indicated by the LDEV list. The maintenance failure tool 31 acquires the information of the drive type and the RAID level of the parity group (RAID group) that allocates the storage area to the target LDEV from the storage system 1 (S14, S15).

Further, the maintenance failure tool 31 acquires information on a size (capacity) and a usage rate (data storage rate) of the target LDEV from the storage system 1 (S16, S17). The amount of data stored in the LDEV is determined based on the capacity and the usage rate. The usage rate indicates a usage status of a drive that stores the data of the LDEV. It is assumed that test data is stored in the LDEV in advance. The maintenance failure tool 31 can use storage management software executed by the test execution client 3 to acquire information of these items. The storage management software acquires information from the storage system 1 instead of the test execution client 3.

Next, the maintenance failure tool 31 calculates a timeout period for the target LDEV (S18). Specifically, the maintenance failure tool 31 acquires the coefficient of the target LDEV from the timeout period derivation table 32. The coefficient is determined based on the storage model, drive type, and RAID level of the target LDEV. The maintenance failure tool 31 calculates the timeout period based on the acquired coefficient, LDEV size, and usage rate according to the above equation.

Next, the maintenance failure tool 31 issues a command for instructing the execution of the verification process to the storage system 1 (S19). The maintenance PC 5 may load the verification object file 51 into the storage system 1 immediately before step S19. That is, the verification object file 51 may be loaded and deleted for each LDEV, or may be deleted after the verification of all the test target LDEVs of the storage system 1 is ended.

Next, the maintenance failure tool 31 acquires a verification start time (S20). The start time may be acquired from the storage system 1, or may be an issuance time of a verification command.

Next, the maintenance failure tool 31 repeatedly executes steps S21 to S23 until the loop is terminated. First, after waiting for specified seconds (S21), the maintenance failure tool 31 determines whether the verification process is ended or is still ongoing (S22).

For example, when the verification process ends, the storage system 1 transmits a service information message (SIM) indicating a result to the test execution client 3. The maintenance failure tool 31 determines whether the verification process is ended or is still ongoing depending on whether the SIM is received. Alternatively, the maintenance failure tool 31 may issue a verification progress check command to the storage system 1, and make a determination with reference to a response thereof.

When the verification process is still ongoing (S22: Y), the maintenance failure tool 31 acquires a current time, and calculates an elapsed time from the verification start time. The maintenance failure tool 31 compares the elapsed time with the calculated timeout period, and determines whether a timeout occurs (S25). When the elapsed time does not reach the timeout period (S25: N), the flow returns to step S21.

When the elapsed time reaches the timeout period (S25: Y), it is determined that there is no response, the flow returns to step S17, and the timeout period is calculated again when the usage rate of the LDEV is changed by an IO process or a background process during the timeout period. When the timeout occurs (S25: Y), the flow may return to step S19.

When the verification process is ended (S22: N), the maintenance failure tool 31 determines whether the verification process is normally ended or an error is detected by referring to the SIM (S23). When the verification process is normally ended (S23: Y), the verification process of the target LDEV is ended, and the next LDEV is selected from the LDEV list. When the verification process is not normally ended (S23: N), the maintenance failure tool 31 outputs an error message on the output device 304, for example, a display device (S26). Thereafter, the next LDEV is selected from the LDEV list.

In the above example, the process executed by the maintenance failure tool 31 may be executed by the controller 12 of the storage system 1 instead. The verification process may be executed in a test of the storage system 1, or may be executed during operation of the storage system 1.

In the above example, the retry is repeated during the timeout of the verification process. In general, since the timeout is often caused by a temporary failure, the verification process can be reliably ended. In another example, an upper limit value may be set for the number of times of the retry. When the number of times of the retry reaches the upper limit value, the maintenance failure tool 31 stops the verification process of the target LDEV and outputs the error message.

The maintenance failure tool 31 may shorten the timeout period according to the repetition of the retry (increase in the number of times of the retry). The shortening of the timeout may be executed for each retry, or may be executed every time a plurality of times of the retry are executed. A shortened time length may be constant, or may change as the number of times of the retry increases. By shortening the timeout period, it is possible to reduce a waiting time when the verification process is stalled.

The invention is not limited to the embodiments described above, and includes various modifications. For example, the embodiment described above has been described in detail to facilitate understanding of the invention, and the invention is not necessarily limited to those including all configurations described above. A part of a configuration of a certain embodiment can be replaced with a configuration of another embodiment, and a configuration of another embodiment can be added to a configuration of a certain embodiment. A part of a configuration of each embodiment may be added to, deleted from, or replaced with another configuration.

Some or all of configurations, functions, processing units, and the like described above may be implemented by hardware by, for example, designing with an integrated circuit. The above configurations, functions, or the like may be implemented by software by a processor interpreting and executing a program for implementing each function. Information such as a program, a table, and a file for implementing the functions can be stored in a recording device such as a memory, a hard disk, or SSD, or a recording medium such as an IC card, and an SD card.

Further, control lines and information lines are those considered to be necessary for description, and not all control lines and information lines are necessarily shown in the product. Actually, it may be considered that almost all configurations are connected to one another.

What is claimed is:

1. An apparatus for managing a verification process in a storage system, the apparatus comprising:
a processor; and
a storage device, wherein
the processor
determines an amount of data stored in a target logical device of a verification process,
determines a timeout period of the target logical device based on the amount of data, and
controls the verification process of the target logical device based on the determined timeout period.

2. The apparatus according to claim 1, wherein
the processor executes retry of the verification process when an elapsed time of the verification process reaches the timeout period.

3. The apparatus according to claim 1, wherein
the storage device stores timeout management information for managing information for determining a timeout period of a verification process,
the timeout management information stores a coefficient associated with a drive attribute, and
the processor acquires a coefficient corresponding to an attribute of a drive storing data of the target logical device from the timeout management information, and determines a timeout period for the target logical device based on the acquired coefficient and the amount of data.

4. The apparatus according to claim 3, wherein
the drive attribute indicates a RAID level of a RAID group that stores data of a logical device.

5. The apparatus according to claim 3, wherein
the drive attribute indicates a drive type of a drive that stores data of a logical device.

6. The apparatus according to claim 3, wherein
the timeout management information further associates a model of the storage system with the coefficient,
the drive attribute indicates a RAID level of a RAID group that stores data of a logical device and a drive type, and
the processor refers to the timeout management information, and determines the timeout period based on an amount of data, a RAID level, and a drive type of the target logical device, and the model of the storage system.

7. The apparatus according to claim 1, wherein
the processor
repeats retry of the verification process with respect to repetition of elapse of the timeout period, and
shortens the timeout period according to the repetition of the retry.

8. The apparatus according to claim 1, wherein
the apparatus is a test apparatus that executes a test of the storage system, and
a program for the storage system to execute the verification process is loaded from an apparatus different from the test apparatus.

9. A method for controlling a verification process of a storage system by an apparatus, the method comprising:
determining, by the apparatus, an amount of data stored in a target logical device of a verification process;
determining, by the apparatus, a timeout period of the target logical device based on the amount of data; and
controlling, by the apparatus, the verification process of the target logical device based on the determined timeout period.
